(19) United States
(12) Patent Application Publication
(10) Pub. No.: US 2015/0029310 A1
(43) Pub. Date: Jan. 29, 2015

(54) OPTICAL SYSTEM AND METHOD FOR ACTIVE IMAGE ACQUISITION

(71) Applicant: NATIONAL CHIAO TUNG UNIVERSITY, Hsinchu (TW)

(72) Inventors: CHUNG-HAO TIEN, Hsinchu (TW); SHENG-HSUN HSIEH, Hsinchu (TW); SHAO-HUNG HUANG, Hsinchu (TW)

(73) Assignee: NATIONAL CHIAO TUNG UNIVERSITY, Hsinchu (TW)

(21) Appl. No.: 14/152,641

(22) Filed: Jan. 10, 2014

(30) Foreign Application Priority Data
Jul. 23, 2013 (TW) 102126305

(51) Int. Cl. H04N 13/02

(52) U.S. Cl. CPC H04N 13/0203
USPC 348/46

(57) ABSTRACT

An active image acquisition system and method are introduced. The active image acquisition system retrieves light information of an object for creating an object model. The active image acquisition system includes a processing unit, a light-emitting unit and a capturing unit. The processing unit generates a plurality of modulating signals and a plurality of synchronous signals seriatim. The light emitting unit modulates a first light beam by the modulating signals, and the first light beam is emitted to the object. The object reflects a second light beam after the first light beam incident into the object with the light information. The capturing unit generates an image after capturing the second light beam in each modulating signals modulating the first light beam. The processing unit performs a first algorithm for calculating a plurality of the images and the modulating signals, and creating the object model.

### CROSS-REFERENCE TO RELATED APPLICATION

This non-provisional application claims priority under 35 U.S.C. §119(a) on Patent Application No(s).102126305 filed in Taiwan, R.O.C. on Jul. 23, 2013, the entire contents of which are hereby incorporated by reference.

### FIELD OF THE INVENTION

The present invention relates to computer imaging optical techniques, and more particularly, to creating an object model carrying depth information and spectral information and an optical method thereof.

### BACKGROUND OF THE INVENTION

According to the prior art, light field information about an object is captured by a computer imaging optical (also known as digital optical) technique to construct an object model. The computer imaging optical technique results from integration of a conventional an imaging optical system and a digital image processing technique.

The U.S. Pat. No. 5,135,309 provides an optical method for performing non-contact measurement of an object to acquire information about surfaces and depth of the object by structure optical encoding. The U.S. Pat. No. 7,415,151B2 provides a method of acquiring information about the depth of an object and a colorful image by colorful structure optical encoding. The United States patent US2010/0073504 provides a method of controlling on-off of a light-emitting diode array to modulate illumination spectrum and capture an image and thereby calculate surface reflectance spectrum of an object. In fact, the methods of the above patents are characterized in that, during a specific period of time, the object undergoes one-time superficial depth information capture, color information capture, or spectral image capture. Although the methods are effective in capturing the light field information of the object, an error occurs to the light field information captured because of environmental factors, such as color temperature, in the course of the capture process.

In view of the aforesaid drawbacks of the prior art, the present invention provides an optical system and method for active image acquisition

### SUMMARY OF THE INVENTION

It is an objective of the present invention to provide an optical system for active image acquisition, the optical system capturing light field information about an object for creating an object model, the optical system comprising a processing unit, a light-emitting unit, and a capturing unit. At least one of an intensity of the first light beam, a wavelength of the first light beam, a spectral distribution of the first light beam, and a pattern projected by the first light beam is changed according to the modulating signals generated from the processing unit. The capturing unit captures a second light beam carrying light field information and reflected off the object on which the first light beam is incident, so as to create an object model.

Another objective of the present invention is to provide an optical method for active image acquisition to capture light field information about an object for creating an object model.

In order to achieve the above and other objectives, the present invention provides an optical system for active image acquisition. The optical system captures light field information about an object for creating an object model. The optical system comprises a processing unit, a light-emitting unit, and a capturing unit. The processing unit generates a plurality of modulating signals and a plurality of synchronous signals in sequence, wherein the modulating signals each correspond to a corresponding one of the synchronous signals. The light-emitting unit is connected to the processing unit and adapted to modulate a first light beam according to the modulating signals, wherein the modulated first light beam falls on the object to cause a second light beam to be reflected off the object, the second light beam pertaining to light field information of the object. The capturing unit is connected to the processing unit and adapted to capture the second light beam and thereby form images according to the synchronous signals while the modulating signals are each modulating the first light beam. The processing unit executes a first algorithm to compute the images and the modulating signals so as to generate an algorithmic result, and the processing unit creates the object model according to the algorithmic result.

In order to achieve the above and other objectives, the present invention provides an optical method for active image acquisition, adapted to capture light field information about an object for creating an object model, and employing an active image acquisition optical system comprising a processing unit, a light-emitting unit, and a capturing unit, the active image acquisition method comprising the steps of: (a) generating a plurality of modulating signals and a plurality of synchronous signals in sequence by the processing unit; (b) sending the modulating signals to the light-emitting unit and the synchronous signals to the capturing unit; (c) modulating a first light beam generated from the light-emitting unit according to each of the modulating signals, and changing at least one of an intensity of the first light beam, a wavelength of the first light beam, a spectral distribution of the first light beam, and a pattern projected by the first light beam according to the modulating signals; (d) allowing the first light beams to fall on the object under test and a second light beam to be reflected off the object under test as a result of each of the first light beams incident on the object under test, wherein the second light beam carries light field information pertaining to the object under test; (e) driving the capturing unit by the synchronous signals to enable the capturing unit to capture the second light beam for forming images while the modulating signals are each modulating the first light beam; (f) executing a first algorithm by the processing unit to compute the images and the modulating signals so as to generate an algorithmic result; and (g) creating the object model by the processing unit according to the algorithmic result.

### BRIEF DESCRIPTION OF THE DRAWINGS

Objectives, features, and advantages of the present invention are hereunder illustrated with specific embodiments in conjunction with the accompanying drawings, in which:

FIG. 1 is a schematic view of an optical system for active image acquisition according to the first embodiment of the present invention;

FIG. 2 is a schematic view of light field information about an object shown in FIG. 1;

FIGS. 3a, 3b are schematic views of spectral distribution and pattern of a first light beam shown in FIG. 1;

FIG. 4 is a schematic view of an optical system for active image acquisition according to the second embodiment of the present invention; and

FIG. 5 is a flow chart of an optical method for active image acquisition according to an embodiment of the present invention.

### DETAILED DESCRIPTION OF THE PREFERRED EMBODIMENTS

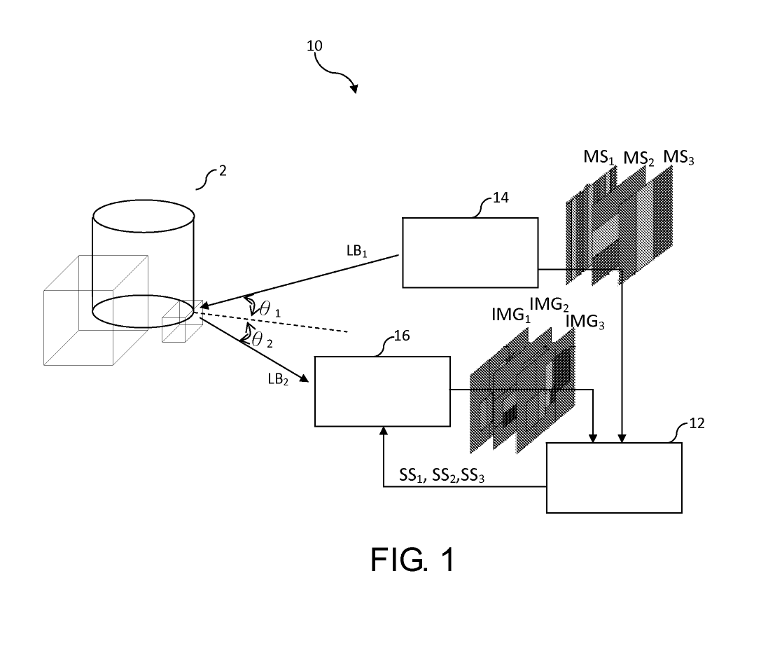

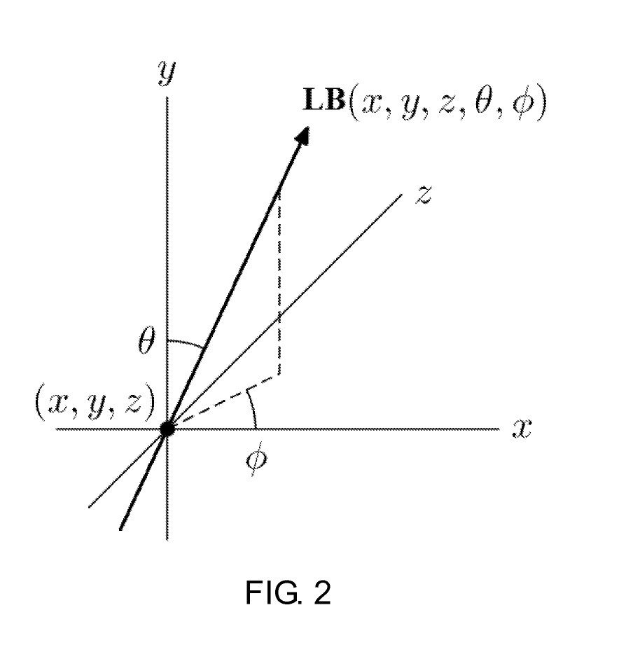

Referring to FIG. 1, there is shown a schematic view of an optical system 10 for active image acquisition according to the first embodiment of the present invention. As shown in FIG. 1, the optical system 10 creates an object model according to captured light field information of an object 2. The light field information pertains to a light field angle (θ, φ) and a position (x, y, z) of a light beam LB in a three-dimensional space, as shown in FIG. 2. The light field angle θ is defined as the included angle between the y-axis and the component of the light beam LB on a plane formed by the x-axis and the y-axis. The light field angle φ is defined as the included angle between the x-axis and the component of the light beam LB on a plane formed by the x-axis and the z-axis.

Referring to FIG. 1, the optical system 10 comprises a processing unit 12, a light-emitting unit 14, and a capturing unit 16.

During a specific period of time, the processing unit 12 generates a first modulating signal MS1, a second modulating signal MS2, and a third modulating signal MS3 in sequence, whereas the processing unit 12 generates a first synchronous signal SS1, a second synchronous signal SS2, and a third synchronous signal SS3 in sequence. The modulating signals MS1, MS2, MS3 modulate a first light beam LB1 emitted from the light-emitting unit 14. The synchronous signals SS1, SS2, SS3 drive the capturing unit 16 to capture a second light beam LB2 reflected off the object 2 as a result of the first light beam LB1 which falls on the object 2. For example, the processing unit 12 generates the first modulating signal MS1 and the first synchronous signal SS1 simultaneously; hence, the capturing unit 14 is driven by the first synchronous signal SS1 to capture a second light beam LB2 reflected off the object 2 while the light-emitting unit 12 is modulating the first light beam LB1 according to the first modulating signal MS1. By analogy, according to the second synchronous signal SS2, the capturing unit 14 captures another second light beam LB2 reflected off the object 2 as a result of the first light beam LB1 modulated by the second modulating signal MS2. According to the third synchronous signal SS3, the capturing unit 14 captures yet another second light beam LB2 reflected off the object 2 as a result of the first light beam LB1 modulated by the third modulating signal MS3.

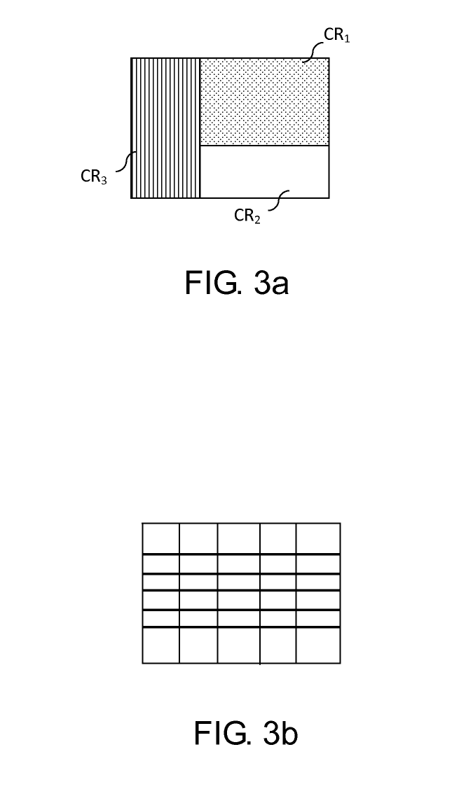

For example, the modulating signals MS1, MS2, MS3 modulate the light intensity (i.e., brightness) of the first light beam LB1. The spectral distribution of the first light beam LB1, which is shown in FIG. 3a, pertains to a first color region CR1, a second color region CR2, and a third color region CR3, the wavelength (and thus color) of the first light beam LB1, and/or a pattern formed on the object 2 by the first light beam LB1 (for example, the pattern are lines or squares, as shown in FIG. 3b.) Hence, the first light beam LB1 not only modulates light intensity solely but also modulates light intensity and spectral distribution simultaneously.

The light-emitting unit 14 is connected to the processing unit 12 to thereby receive the modulating signals MS1, MS2, MS3. For instance, the light-emitting unit 12 includes a projector and/or a light-emitting diode array. In the first embodiment of the present invention, the light-emitting unit 14 is exemplified by a projector.

The light-emitting unit 14 modulates the first light beam LB1 according to the first modulating signal MS1, for example, and emits the modulated first light beam LB1 to the object 2. According to the law of reflection, the first light beam LB1 falls on the object 2 to cause the second light beam LB2 to be reflected off the object 2. The second light beam LB2 carries light field information pertaining to the object 2. The law of reflection states that, if a light beam strikes a surface at an angle of incidence (the angle of incidence is defined as an included angle between the light beam and a normal) and then the light beam is reflected off the surface at an angle of reflection (the angle of reflection is defined as another included angle between the light beam and the normal), the angle of incidence equals the angle of reflection. In the first embodiment of the present invention, the first light beam LB1 is incident on the surface of the object 2 at a first angle θ₁, and then the first light beam LB1 (i.e., the aforesaid second light beam LB2) is reflected off the surface of the object 2 at a second angle θ₂, wherein the first angle θ₁ equals the second angle θ₂.

The capturing unit 16 is connected to the processing unit 12 and adapted to receive the synchronous signals SS1, SS2, SS3. For instance, the capturing unit 16 is a RGB colored camcorder or a monochromatic camcorder. For instance, in the course of the modulation of the first light beam LB1 by the first modulating signal MS1, the capturing unit 16 captures the second light beam LB2 according to the first synchronous signal SS1 so as to generate a first image IMG1. By analogy, the capturing unit 16 captures the second light beam LB2 according to the second synchronous signal SS2 so as to generate a second image IMG2. By analogy, the capturing unit 16 captures the second light beam LB2 according to the third synchronous signal SS3 so as to generate a third image IMG3.

Afterward, the processing unit 12 executes a first algorithm (not shown) to compute the images IMG1, IMG2, IMG3 and the modulating signals MS1, MS2, MS3 so as to generate an algorithmic result. Referring to FIG. 1, understandably, as regards the first image IMG1, a pattern, which is displayed on the object 2 as a result of a light beam cast from the light-emitting unit 14 to the object 2, deforms according to the shape and position of the object 2. The processing unit 12 computes the difference to thereby generate the algorithmic result and then creates an object model according to the algorithmic result. For example, the algorithmic result pertains to a three-dimensional depth information, an image spectral distribution information, an image variation information, and/or a light field angle information. In another embodiment, the processing unit 12 dynamically adjusts the modulating signals after it analysis the images IMG1, IMG2, IMG3 immediately generated form the capturing unit 16. In other words, before the processing unit 12 generates each the modulating signal MS1, MS2, MS3, it first analysis the feedback the image.

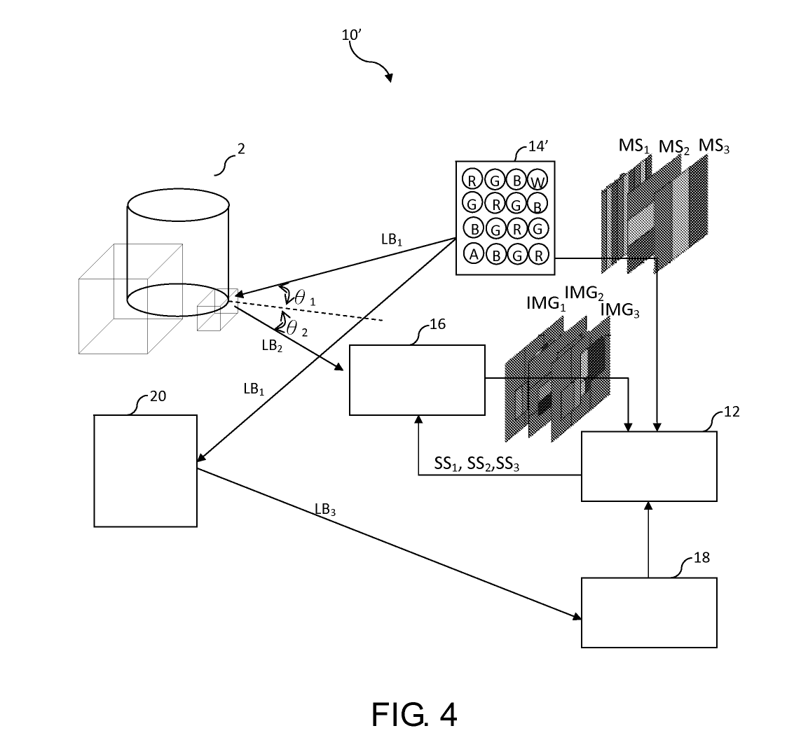

Referring to FIG. 4, there is shown a schematic view of an optical system 10′ for active image acquisition according to the second embodiment of the present invention. As shown in FIG. 4, the optical system 10′ not only comprises the processing unit 12 and the capturing unit 16 of first embodiment, but also comprises a light-emitting unit 14′ and a measurement unit 18.

In the second embodiment of the present invention, the light-emitting unit 14′ is exemplified by a light-emitting diode array. The light-emitting diode array comprises a plurality of light-emitting diodes 142. The light-emitting diodes 142 each generate a light beam with a wavelength of 400 nm to 700 nm, that is, one within the visible light spectrum. In the second embodiment of the present invention, the light-emitting diode array comprises the light-emitting diodes 142 which generate red light (R), green light (G), blue light (B), amber light (A), and white light (W), respectively.

The measurement unit 18 is connected to the processing unit 12. For example, the measurement unit 18 comes in the form of a spectrometer. The measurement unit 18 captures a third light beam LB3 reflected off a standard color patch 20 on which the first light beam LB1 is incident. The measurement unit 18 executes a second algorithm for computing the difference between the optical spectrum distribution of the third light beam LB3 and the optical spectrum distribution of the standard color patch 20 so as to generate a conversion relation (not shown). The processing unit 12 switches the images from a first optical spectrum to a second optical spectrum according to the conversion relation. The first light beam LB1 emitted from the light-emitting unit 14′ is likely to undergo color shift; as a result, the capturing unit 16 captures erroneous light field information. Hence, the light-emitting unit 14′ performs optical spectrum calibration on the first light beam LB1 according to the conversion relation, thereby enabling the processing unit 12 to create the object model correctly.

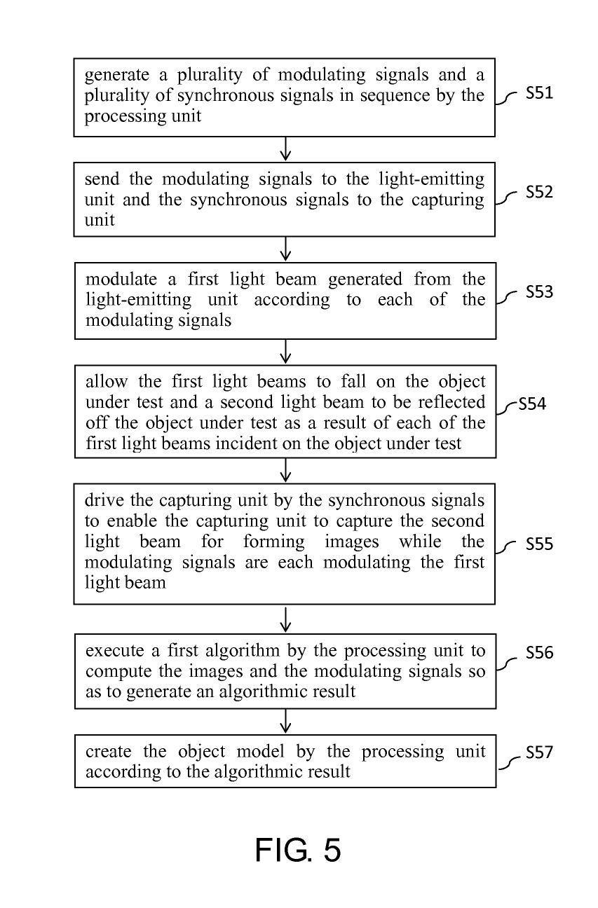

Referring to FIG. 5, there is shown a flow chart of an optical method for active image acquisition according to an embodiment of the present invention. As shown in FIG. 5, the optical method for the active image acquisition is for use in capturing light field information about an object for creating an object model, and employs the active image acquisition optical system which comprises a processing unit, a light-emitting unit, and a capturing unit.

The process flow of the active image acquisition method starts with step S51.

Step S51: generating a plurality of modulating signals and a plurality of synchronous signals in sequence by the processing unit;

Step S52: sending the modulating signals to the light-emitting unit and the synchronous signals to the capturing unit;

Step S53: modulating a first light beam generated from the light-emitting unit according to each of the modulating signals, and changing an intensity of the first light beam, a wavelength of the first light beam, a spectral distribution of the first light beam, and/or a pattern projected by the first light beam according to the modulating signals.

Step S54: allowing the first light beams to fall on the object under test and a second light beam to be reflected off the object under test as a result of each of the first light beams incident on the object under test, wherein the second light beam carries light field information pertaining to the object under test.

Step S55: driving the capturing unit by the synchronous signals to enable the capturing unit to capture the second light beam for forming images while the modulating signals are each modulating the first light beam.

Step S56: executing a first algorithm by the processing unit to compute the images and the modulating signals so as to generate an algorithmic result.

Step S57: creating the object model by the processing unit according to the algorithmic result.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. An optical system for active image acquisition, the optical system capturing light field information about an object for creating an object model, the optical system comprising:
a processing unit for generating a plurality of modulating signals and a plurality of synchronous signals in sequence, wherein the modulating signals each correspond to a corresponding one of the synchronous signals;
a light-emitting unit connected to the processing unit and adapted to modulate a first light beam according to the modulating signals, wherein the modulated first light beam falls on the object to cause a second light beam to be reflected off the object, the second light beam pertaining to light field information of the object; and
a capturing unit connected to the processing unit and adapted to capture the second light beam and thereby form images according to the synchronous signals while the modulating signals are each modulating the first light beam,
wherein the processing unit executes a first algorithm to compute the images and the modulating signals so as to generate an algorithmic result, and the processing unit creates the object model according to the algorithmic result.

2. The optical system of claim 1, wherein, according to the modulating signals, the light-emitting unit modulates at least one of intensity of the first light beam, spectral distribution of the first light beam, wavelength of the first light beam, and a pattern formed on the object by the first light beam.

3. The optical system of claim 2, wherein the light-emitting unit is at least one of a projector and a light-emitting diode array.

4. The optical system of claim 3, wherein the light-emitting diode array comprises a plurality of light-emitting diode, and the light-emitting diodes each generate a light beam with a wavelength of 400 nm to 700 nm, that is, one within the visible light spectrum.

5. The optical system of claim 1, further comprising a measurement unit connected to the processing unit and adapted to capture a third light beam reflected off a standard color patch on which the first light beam is incident and execute a second algorithm to compute a difference between optical spectrum distribution of the third light beam and optical spectrum distribution of the standard color patch so as to generate a conversion relation.

6. The optical system of claim 5, wherein the processing unit switches the images from a first optical spectrum to a second optical spectrum according to the conversion relation.

7. The optical system of claim 1, wherein the algorithmic result pertains to at least one of a three-dimensional depth information, an image spectral distribution information, an image variation information, and a light field angle information.

8. An optical method for active image acquisition, adapted to capture light field information about an object for creating an object model, and employing an active image acquisition optical system comprising a processing unit, a light-emitting unit, and a capturing unit, the active image acquisition method comprising the steps of:
generating a plurality of modulating signals and a plurality of synchronous signals in sequence by the processing unit;
sending the modulating signals to the light-emitting unit and the synchronous signals to the capturing unit;
modulating a first light beam generated from the light-emitting unit according to each of the modulating signals, and changing at least one of an intensity of the first light beam, a wavelength of the first light beam, a spectral distribution of the first light beam, and a pattern projected by the first light beam according to the modulating signals;
allowing the first light beams to fall on the object under test and a second light beam to be reflected off the object under test as a result of each of the first light beams incident on the object under test, wherein the second light beam carries light field information pertaining to the object under test;
driving the capturing unit by the synchronous signals to enable the capturing unit to capture the second light beam for forming images while the modulating signals are each modulating the first light beam;
executing a first algorithm by the processing unit to compute the images and the modulating signals so as to generate an algorithmic result; and
creating the object model by the processing unit according to the algorithmic result.
